(19) United States
(12) Patent Application Publication
(10) Pub. No.: US 2013/0244123 A1
(43) Pub. Date: Sep. 19, 2013

(54) BIOCATHODE-PHOTOANODE DEVICE AND METHOD OF MANUFACTURE AND USE

(71) Applicants: G. Tayhas R. Palmore, Providence, RI (US); Sung Yeol Kim, Cambridge, MA (US)

(72) Inventors: G. Tayhas R. Palmore, Providence, RI (US); Sung Yeol Kim, Cambridge, MA (US)

(73) Assignee: Brown University, Providence, RI (US)

(21) Appl. No.: 13/642,608

(22) PCT Filed: Apr. 19, 2011
(86) PCT No.: PCT/US11/32954

§ 371 Date: May 22, 2013

Related U.S. Application Data
(60) Provisional application No. 61/326,301, filed on Apr. 21, 2010.

(51) Int. Cl. H01M 14/00; H01M 8/16

(52) U.S. Cl. CPC H01M 14/005; H01M 8/16
USPC 429/401

(57) ABSTRACT

A system for harvesting electric energy from illumination by photons by photo- and bioelectrocatalysis includes an electrode coated with conducting polymer matrix containing the oxidoreductase, laccase, and a redox mediator, 2,2′-azino-bis(3-ethylbenzothiaxoline-6-sulfonic acid (ABTS). The photo-anode is based on nanocrystalline TlO2 (Degussa, P25) adhered to a fluorine tin oxide (FTO) electrode. The device operation is based on a continuous photocatalytic oxidation of water to oxygen at a TiO2-photoanode and bioelectrocatalytic reduction of oxygen to water at a biocathode under illumination with light.

### CROSS-REFERENCES TO RELATED APPLICATIONS

This application claims the benefit of prior filed U.S. provisional Application No. 61/326,301, filed Apr. 21, 2010.

### BACKGROUND OF THE INVENTION

The invention is directed to a device and method for harvesting energy from light based on an electrochemical system fabricated from a biocathode and a photoanode. The invention is also directed to a method of manufacture of an electrochemical system fabricated from a biocathode and a photoanode and its use.

Light can be converted into electricity by photovoltaic cells and subsequently stored as chemical energy in a battery or in the form of hydrogen via electrolysis of water. Fujishima and Honda (A. Fujishima, K. Honda, Nature 1972, 238, 37) have reported photoelectrolysis of water using a TiO₂ photoanode for oxygen evolution connected to a platinum counter electrode for hydrogen evolution. Various other metal oxides and a dye/catalyst system have been reported, sometimes improving the efficiency of photocurrent generation in the photoelectrolysis of water.

Biofuel cells produce electricity using enzymes or even entire organisms. Typical enzymes used in these devices include glucose oxidase in the anode compartment and laccase in the cathode compartment. Laccase is a multi-copper enzyme that catalyzes the reduction of oxygen to water reduction in the presence of phenolic substrates. The redox-mediator 2,2′-azino-bis(3-ethylbenzthiazoline-6-sulphonic acid) (ABTS) has been shown to be a suitable substrate for laccase by facilitating electron transfer between a cathode and active site of laccase.

Other types of hybrid photovoltaic cells including biofuel cells have been developed, which include a dye-sensitized semiconductor photoanode working in combination with an enzyme-catalyzed biofuel cell and whole cell bioanode with oxidoreductase bioanode.

Photoelectrochemical biofuel cells incorporate aspects of both enzymatic biofuel cells and dye-sensitized solar cells. They rely on charge separation at a porphyrin-sensitized n-type semiconductor photoanode, in close analogy with dye-sensitized solar cells (DSSCs). Following photoinduced charge separation, the phorphyrin radical cation is reduced by β-nicotinamide adenine dinucleotide (NADPH) in the aqueous anodic solution, ultimately generating the oxidized form of the mediator, NAD(P)⁺, after two electron transfers to the photoanode. In turn, NAD(P)⁺ serves as a substrate for dehydrogenase enzymes in the anodic solution, with the enzymatic oxidation of biofuel leading to the regeneration of NADPH. The enzyme-catalyzed and NAD(P)-mediated electron transfer between the biofuel and the photoanode resembles enzymatic biofuel cell operation. However, a larger open-circuit voltage is theoretically achievable in the photoelectrochemical biofuel cell because the photochemical step raises the energy of electrons entering the external circuit at the anode.

A photosynthetic bioelectrochemical cell involves an anode made of cyanobacteria (whole cell) and its mediator, 2,6-dimethyl-1,4-benzoquinone (DMBQ) or diaminodurene (DAD). The electron pumped up in the photosystem is transferred to a carbon felt anode through the mediator. The overall anodic half-cell reaction is the oxidation of water to produce dioxygen and proton. The electron is passed to dioxygen to regenerate water in the cathodic half-cell reaction through ABTS as a mediator and BOD as a biocatalyst.

It would therefore be desirable to obviate disadvantages of prior art system by providing a photovoltaic system which has a higher open circuit voltage, a reduced internal resistance, and which can be manufactured more cost-effectively.

### SUMMARY OF THE INVENTION

The system according to the invention employs a novel concept based on photo (photoelectrolysis)-biocatalysis.

According to one aspect of the invention, a system and method for energy harvesting couples photoactive materials such as TiO₂ with oxidoreductases such as laccase to produce electrical power autonomously. As such, this device is amenable to a variety of photocatalysts and biocatalysts selected for specific environments and applications.

The biocathode of this system consists of an electrode coated with conducting polymer matrix containing the oxidoreductase, laccase, and a redox mediator, 2,2′-azino-bis(3-ethylbenzothiaxoline-6-sulfonic acid (ABTS). The photo-anode is based on nanocrystalline TiO₂ (Degussa, P25) adhered to a fluorine tin oxide (FTO) electrode. This device is based on the continuous photocatalytic oxidation of water to oxygen at a TiO₂-photoanode and bioelectrocatalytic reduction of oxygen to water at a biocathode.

Illumination of the TiO₂ anode with UV light generates electron-hole pairs. Water is oxidized to oxygen by the photo-generated holes while electrons are injected simultaneously into the conduction band of TiO₂. Electrons flow through an external circuit to the biocathode due to a voltage difference of 1.0 V at open circuit between the biocathode (0.6V vs. Ag/AgCl) and the potential of the conduction band of TiO₂ (approx. −0.4V vs. Ag/AgCl). At the cathode, ABTS• undergoes a one-electron reduction to ABTS. Laccase subsequently oxidizes four equivalents of ABTS to ABTS• to reduce oxygen to water. The design of this system enables its continuous operation in the presence of light. This device can be described as a biofuel cell where fuel is supplied via Fujishima-Honda-type photoelectrolysis of water. Unlike other photovoltaics utilizing an enzyme catalysis, the system according to the invention does not require a separator which generally increases ohmic resistance and the costs of the device.

According to one advantageous feature of the present invention, the system has a higher OCP (˜1V) compared to conventional systems (0.6V to 0.75V). Moreover, the system according to the invention has a simple structure and does not require a fuel supply. In addition, the system according to the invention uses a laccase immobilized electrode, whereas conventional systems generally require a platinum electrode.

### BRIEF DESCRIPTION OF THE DRAWINGS

Other features and advantages of the present invention will be more readily apparent upon reading the following description of currently preferred exemplified embodiments of the invention with reference to the accompanying drawing, in which:

FIG. 1 is a schematic diagram of an energy-conversion device according to the present invention;

FIG. 2a shows the photocurrent of a TiO₂ anode under illumination and in the dark;

FIG. 2b shows linear sweep voltammograms of a PAL-coated cathode purged with N₂ or saturated with O₂;

FIGS. 3a and 3b show discharge curves of different PAL-coated cathodes;

FIG. 4 shows current-dependent cell potentials; current-dependent cell/half-cell potentials (Inset (a)); and power density as a function of cell potential (Inset (b)) for several device configurations;

FIG. 5 shows a SEM image of the surface of the TiO₂-photoanode;

FIG. 6 shows the photovoltaic potential under illumination after a discharge; and

FIG. 7 shows the response of the electrical potential of a PAL|TiO₂ device being discharged at a current of 1 μA during repeated light exposure cycles.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

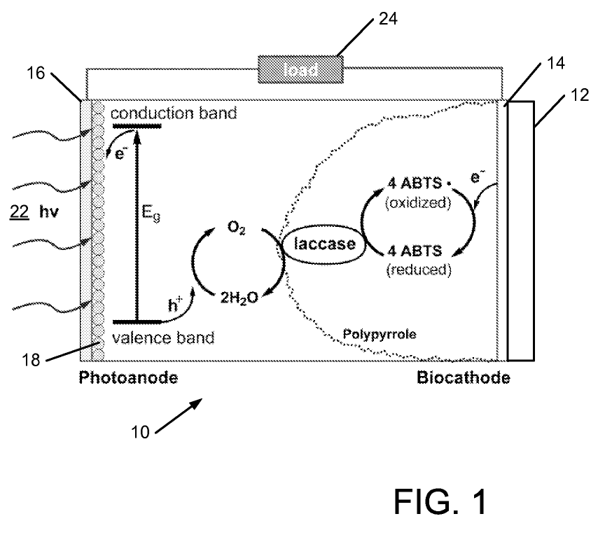

Turning now to the drawing, and in particular to FIG. 1, there is shown an energy-conversion device 10 according to the present invention that utilizes both photo- and bioelectrocatalysis. This device can be described as a biofuel cell where fuel is supplied via Fujishima-Honda-type photoelectrolysis of water (Scheme 1). The overall reaction of this system is the reversible inter-conversion of oxygen and water. The cathode 12 of the system 10 is made of an electrode coated with conducting polymer matrix 14 containing the oxidoreductase, laccase, and a redox mediator, ABTS. The anode 16 is based on nanocrystalline TiO₂ 18 (Degussa, P25) adhered to a fluorine tin oxide (FTO) electrode 20.

Illumination of the TiO₂ anode with UV light 22 generates electron-hole pairs. Water is oxidized to oxygen by the photo-generated holes while electrons are injected simultaneously into the conduction band of TiO₂. Electrons flow through an external circuit 24 to the biocathode 12 due to a voltage difference of 1.0 V at open circuit between the biocathode 12 (0.6V vs. Ag/AgCl) and the potential of the conduction band of TiO₂ 18 (approx. −0.4V vs. Ag/AgCl). At the cathode 12, ABTS• undergoes a one-electron reduction to ABTS. Laccase subsequently oxidizes four equivalents of ABTS to ABTS• to reduce oxygen to water. Continuous catalytic turnover of water and oxygen is made possible by the photoelectrochemical oxidation of water and the bioelectrocatalytic reduction of oxygen in the presence of light 22.

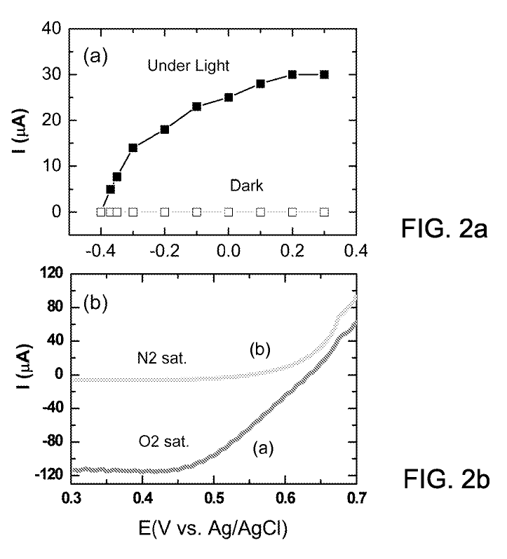

FIG. 2 shows potential-dependent photocurrent of TiO₂ anode under illumination or in the dark (FIG. 2a) and linear sweep voltammograms of a PAL-coated cathode in 0.2M phosphate buffer purged with N₂ or saturated with O₂ (FIG. 2b). The relationship between electrode potential and photocurrent generated by the TiO₂ anode is shown in the FIG. 2a. Onset of photocurrent occurs at −0.4V vs. Ag/AgCl when the TiO₂ anode is illuminated with UV light. Under illumination, the photocurrent increases with increasing positive shift in the potential until leveling off at 30 μA above 0.3 V vs. Ag/AgCl. In the absence of illumination, negligible photocurrent is generated between −0.4 and 0.4 V vs. Ag/AgCl. The observed increase in photocurrent at more positive potentials is caused by increased charge separation and inhibited recombination of holes and electrons.

FIG. 2b shows linear sweep voltammograms (LSV) of a Polypyrrole/ABTS/laccase (PAL)-coated cathode with and without dioxygen present. When the buffer is saturated with dioxygen (curve a), reductive current is observed at 0.6V vs. Ag/AgCl and continues to increase (in negative value) as the voltage is swept to more negative potentials, reaching a maximum value of about 115 μA/cm² at 0.45 V. This result indicates that laccase catalyzes the reduction of dioxygen to water with the concurrent oxidation of ABTS to ABTS•. Regeneration of this electron source occurs at the cathode when ABTS• is reduced to ABTS, thus completing the bioelectrocatalytic cycle. In the absence of dioxygen (i.e., buffer purged with N₂) (curve b), the bioelectrocatalytic reaction is inoperative and thus no reductive current is observed.

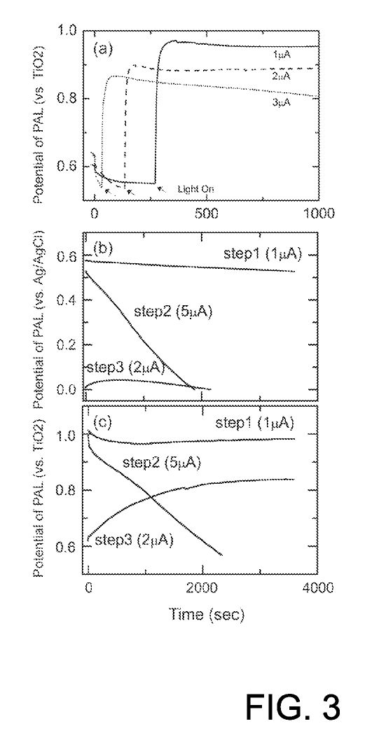

FIG. 3a shows discharge curves of a device fabricated with a PAL-coated cathode and a TiO₂-coated anode (PAL|TiO₂) obtained at 1, 2 and 3 μA current loads. In the absence of light, the potential of PAL decreases rapidly with increasing rates of discharge over the range of 1 μA to 3 μA. Subsequent illumination on the TiO₂-anode results in a sharp increase in the potential for all curves. The equilibrium potential is found to be 0.96V (0.59V vs Ag/AgCl) when the rate of discharge is 1 μA and 0.89V (0.52V vs. Ag/AgCl) when the rate of discharge is 2 μA. The potential gradually decreases when the rate of discharge is 3 μA. All discharge curves are measured in an air-saturated buffer. The influx of additional oxygen is prevented by sealing the device.

FIGS. 3b and 3c show sequential discharge curves of a PAL-coated cathode: step 1 (1 μA, 3600 s); step 2 (SpA, 1900 s); step 3 (2 μA, 2200 s). Both electrodes were 0.9 cm2. The data were obtained during a sequence of three discharge steps are shown in where either carbon or TiO₂-coated FTO electrodes are used as the anode in the device, respectively. The potential of a PAL-coated cathode is monitored during the discharge sequence for each device configuration. During the first step of the sequence (step 1, FIG. 3b), the biocathode is discharged at a current of 1 μA. For the device with a carbon anode, the potential of the biocathode decreases only slightly from 0.58V to 0.52V vs. Ag/AgCl over the discharge time. The biocathode is discharged a second time (step 2, FIG. 3b) at a current of SpA, which causes a rapid decrease in the potential of the biocathode from 0.58V to 0V vs. Ag/AgCl. Finally, the biocathode is discharged a third time (step 3, FIG. 3b) at a current of 2 μA. The potential of the biocathode remains near 0V, thus indicating that all oxygen had been depleted from the electrolyte during the first and second discharge steps.

In FIG. 3c, the device is reconfigured with a TiO₂-photoanode, illuminated with UV light, and subjected to the same sequence of discharge steps as before. In this case, the potential of the PAL-coated cathode remains constant at 0.58V vs. Ag/AgCl (0.98V vs. TiO₂ photoanode) during the first discharge step (step 1, FIG. 3c). The second discharge step (step 2, FIG. 3c) results in a decrease in the potential of the biocathode, but the rate of decrease is slower than that observed in the previous configuration where the anode is not photoactive (i.e., carbon) (step 1, FIG. 3b). Moreover, even after the biocathode consumed all oxygen in the electrolyte during the discharges in step 1 and step 2, the potential of the biocathode gradually increases from 0V to 0.46V vs. Ag/AgCl (0.38V to 0.84V vs. TiO₂) (step 3, FIG. 3c) and remains constant thereafter. Thus, these data taken together confirm that the oxygen available to the biocathode during the third discharge step is generated at the photoanode.

In addition, the open-circuit potential of the PAL|TiO₂ device is found to be 0.58V vs. TiO₂ in the dark but 0.96V vs. TiO₂ when illumination. These open-circuit potentials correspond to the difference between the potential of the biocathode (0.58V vs. Ag/AgCl with or without illumination) and the TiO₂-photoanode (0V vs. Ag/AgCl in the dark and −0.4V vs. Ag/AgCl when illuminated). The rapid increase in the open-circuit potential of the device when illuminated can be attributed to the decreasing potential of the TiO₂-photoanode from 0V to −0.4V. While the equilibrium potentials of the photovoltaic cell shown in FIGS. 3a and 3c are due to the constant potentials of both the biocathode and the TiO₂-photoanode at low discharge currents (i.e., 1 μA and 2 μA), the decrease in the cell potential of the device at higher discharge currents (i.e., 3 μA and 5 μA) are attributed to a decrease in potential of the biocathode. This decrease suggests that the rate of charge transfer at biocathode is the rate-limiting process in the device. The capacity of biocathode (PAL), therefore, can be increased to improve the performance of the device.

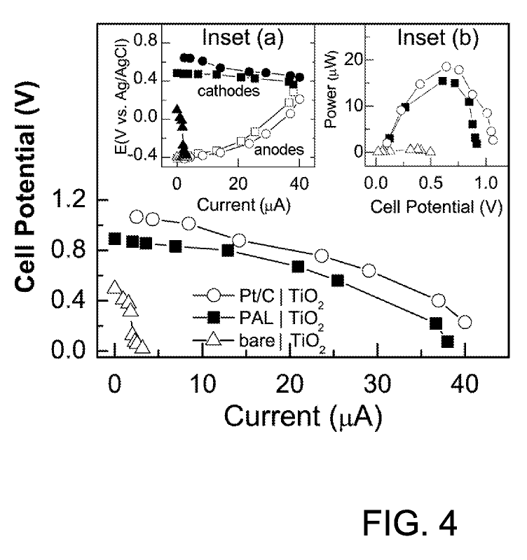

In FIG. 4, the performance of the [PAL|TiO₂] device is compared with that of other device configurations where a cathode of bare or platinum-loaded carbon (Pt/C) is connected to a TiO₂-photanode. A thick film of PAL is electrodeposited onto a porous carbon electrode (Toray carbon paper) to increase the capacity of the biocathode. FIG. 4 (with insets) shows the current density plotted as a function of cell potential for several device configurations: TiO₂-photoanode (area=1 cm²) coupled to a carbon cathode (Toray paper, area=0.5 cm²) embedded with platinum particles (open circles); coated with PAL (filled squares); or uncoated (triangles); current density as a function of half-cell potentials of devices with a TiO₂-photoanodes (open symbols) and different cathodes: bare carbon (filled triangle), PAL-coated carbon (filled squares), and Pt-coated carbon (filled circles); and cell potential as a function of power density.

The open-circuit potentials of bare|TiO₂, PAL|TiO₂ and Pt/C|TiO₂ device configurations were found to be 0.5V, 0.98V and 1.05V respectively. The cell potentials of PAL|TiO₂ and Pt/C|TiO₂ decreases slowly reaching 0V at a current load of 40 μA. These decreases in potential result from the decrease in the potential of the TiO₂-photoanode (from −0.4V at 2 μA to 0.2V at 0.4 μA) are shown in FIG. 4, Inset (a). When the cathode is bare carbon, however, the cell potential drops rapidly with increasing current load, reaching 0V at around 3 μA due to the rapid decrease in the potential of the cathode (from 0.1V at 1 μA to −0.4V at 3 μA), while the potential of TiO₂-photoanode remained constant. FIG. 4, Inset (b) shows the power output of the device as a function of cell potential. The maximum power output of each device configuration is found to be 0.6 μW at 0.38 V for the C|TiO₂, 15.4 μW at 0.61 V for the PAL|TiO₂ device and 18.5 μW at 0.64 V for the Pt/C|TiO₂ device. These results suggest that the performance of the PAL|TiO₂ device is similar to that of a device that used platinum as the cathodic catalyst under identical conditions of pH, temperature, illumination, photoanode, and design.

### Experimental Details

Fabrication and Characterization of a Nanocrystalline TiO₂ Photoanode:

The paste of TiO₂ is prepared by mixing TiO₂ powder (Degussa P-25) with poly(ethylene glycol) (PEG) (MW=15,000-20,000) in water. Alternatively, a paste of TiO₂ is prepared using acetic acid buffer (pH 4) and triton X instead of PEG and water. The paste is coated onto FTO slides (Hartford Glass 10 Ω/sq.). The electrodes are dried in an oven at 80° C. for 30 min and sintered in a furnace at 450° C. for 30 min to improve mechanical contact. Different potentials are applied to the TiO₂ photoanode and the corresponding photocurrents are measured. The reference and counter electrodes are Ag/AgCl and Pt mesh, respectively. A long-range UV lamp (365 nm, Spectroline EN 180) is used as a light source.

Fabrication and Characterization of a Laccase Immobilized Biocathode (PAL):

Polypyrrole films doped with ABTS and laccase (PAL) are electrodeposited onto an electrode surface (gold or carbon/PET) by cycling the potential between 0 and 650 mV (vs. Ag/AgCl) for 40 cycles. Films are electrosynthesized from an aqueous solution containing 0.4M pyrrole, 12.5 mM ABTS and laccase (5 mg/mL). In addition, polypyrrole films doped with only ABTS (pPy[ABTS]) are electrosynthesized and used as a control cathode. Post-synthesis electrolyte used in this study is 0.2M phosphate buffer (pH 4.5). The potential of PAL is swept linearly from 700 mV to 300 mV in buffer solution saturated with either N₂ or O₂.

Photovoltaic Cell Experiment:

PAL-coated cathodes connected to TiO₂-photoanodes are discharged at various rates by applying constant currents of 1, 2, 3 and SpA. Phosphate buffer solution (pH 4.5 0.2M) is used as the electrolyte for all experiments. The electrochemical cell is a quartz cuvette (5 mL) sealed with a Teflon cap and parafilm. Three device configurations (|TiO₂, PAL|TiO₂ and Pt/C|TiO₂) are operated at different external loads by placing a resistor (ranging from 500 kΩ to 0.5 kΩ) in series between the anode and cathode. Cell and half-cell potentials are measured with a digital voltmeter and referenced to Ag/AgCl.

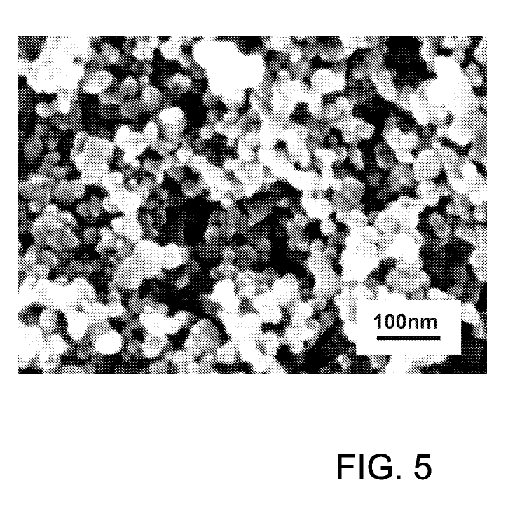

FIG. 5 shows a SEM micrograph of the surface of the TiO₂-photoanode, which reveals the porous nature of the photoactive film consisting of nanoparticles (−25 nm) of TiO₂.

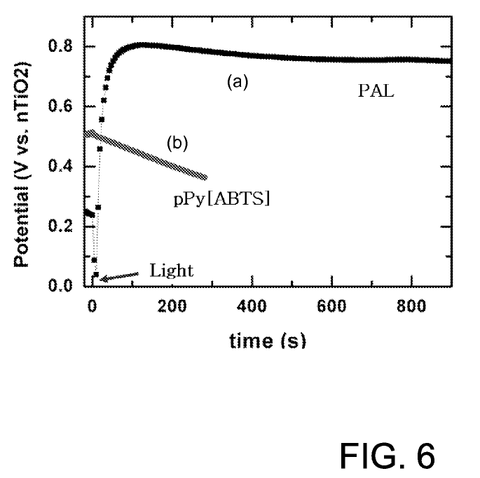

FIG. 6 shows the discharge curve of a PAL-coated cathode (curve a) and a PA-coated cathode (curve b), i.e. a cathode without laccase. The discharge current is 1 μA. The polypyrrole pPy[ABTS]-coated cathode is charged to 500 mV (vs. TiO₂) while the photoanode is illuminated by white light (30 W tungsten halogen lamp, distance=3 cm).

As shown in the FIG. 6, (curve b), an electrodeposited film of polypyrrole/ABTS (without laccase) exhibits a continuous decrease in potential even when the TiO₂-photoanode is illuminated. This result suggests that laccase-catalyzed reduction of oxygen to water is important for maintaining a constant cell potential while subjecting the device to a constant load.

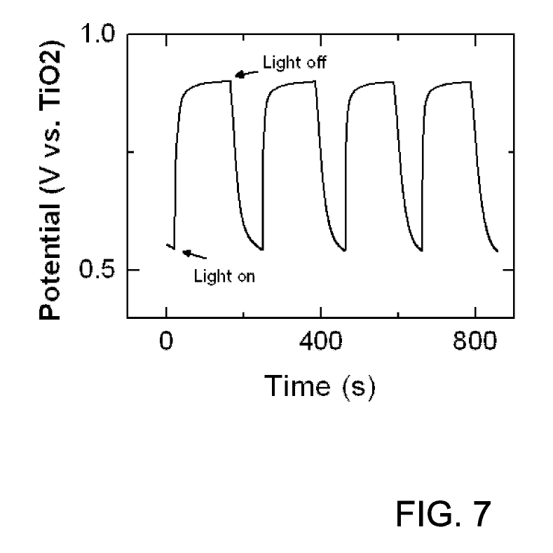

FIG. 7 shows the response of PAL|TiO₂ device being discharged at a current of 1 μA during repeated cycles of light exposure.

In summary, a new method for harvesting energy is demonstrated based on an electrochemical device fabricated from a cathode coated with a polymer composite of polypyrrole, ABTS and laccase, and a photoanode of nanocrystalline TiO₂ adhered to a fluorine tin oxide (FTO) electrode. This device is based on the continuous photocatalytic oxidation of water to oxygen at a TiO₂-photoanode and bioelectrocatalytic reduction of oxygen to water at a biocathode. This device is meant to demonstrate a novel method for energy harvesting the couples inexpensive photoactive materials such as TiO₂ with ubiquitous oxidoreductases such as laccase to produce small amounts of electrical power autonomously. As such, this device is amenable to a variety of photocatalysts and biocatalysts selected for specific environments and applications.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

1. An aqueous photoelectrolysis-biocatalysis device for producing electric power in response to incident light, comprising
a biocathode in contact with water, said biocathode comprising an electrode coated with a conducting polymer matrix comprising an oxidoreductase and a redox mediator and;
a photoanode in contact with said water, said photoanode comprising nanocrystalline TiO₂ adhered to a fluorine tin oxide (FTO) electrode.

2. The device of claim 1 wherein said oxidoreductase is laccase, and said redox mediator is 2,2′-azino-bis(3-ethylbenzothiaxoline-6-sulfonic acid).

3. A method of producing electric power from an aqueous photoelectrolysis-biocatalysis device comprising exposing the device of claim 1 to UV light in the presence of water.
